(19) United States
(12) Patent Application Publication
(10) Pub. No.: US 2009/0036185 A1
(43) Pub. Date: Feb. 5, 2009

(54) Raid zone football

(76) Inventor: Frank Osalo Price, Arlington, VA (US)

Correspondence Address: Frank O. Price, 1712 N. Dinwiddie St., Arlington, VA, 22207, US

(21) Appl. No.: 11/977,525

(22) Filed: Mar. 9, 2007

(51) Int. Cl. A63F 13/00; A63F 9/24

(52) U.S. Cl. 463/4; 463/22; 273/298

(57) ABSTRACT

The RAID-ZONE is a computerized football game for use by a player that includes a monitor, a computerized simulated football field and a playing image adapted to be movably and selectively controlled on the simulated football field. The monitor has a plurality of decks of play select cards, where each card of each of the decks is related to a specific football play with play results thereon. Also, the monitor has a plurality of play select buttons, a start button and a coin slot. The simulated football field has a scoreboard and a card display. Each of the play select buttons selectively controls and displays which play select card will be selected in order to control and determine where the playing image will move to on the simulated football field after a player has inserted the required amount of coins within the coin slot and presses the start button.

### BACKGROUND OF THE INVENTION

1. Field of the Invention

The invention relates to a computerized football game that simulates an actual football where players start from the 20 yard line with four (4) series of downs to score a minimum of a predetermined number of points to win. This computerized game allows the players to play against the odds designed into decks of cards called the defense. The game consists of a plurality of decks of cards that is related to a specific type of football play. Each card having the result of a selected football play printed thereon.

The success in playing the game is based on players' skill and luck against the odds of the cards. The cards are statistically numbered so that the game may be played by players either for fun or money. Note that this game may be played by adults in a casino environment. The players function as quarterbacks on a selected basis and do not need to know the rules to enjoy the game. However, players that watches and understands the real game of football will enable them to be better players.

In addition to playing the role of quarterback, the computer can selectively act as game officials, such as, a referee, an umpire, a field judge and head linesman.

2. Description of the Related Art

Football games have been simulated with cards for many years. Many prior art simulated board games contain electronic type vibrating means to provide movement of football figures on the board to progress up and down a simulated football field. Other simulated type football games utilizes play selecting cards. There are separate offensive and defensive cards. In this game the defensive player first chooses his defensive card. Then the offensive player chooses his card and discloses his choice. The defensive player aligns his/her card containing graphic representations with the gridiron and locates the play result on the card. Live football is played by the offense choosing a play and the defense trying to guess what the play is. This simulated game is described in U.S. Pat. No. 3,103,361, issued Sep. 10, 1963 to R. G. Board.

U.S. Pat. No. 4,173,346 issued Nov. 6, 1979 to William D. Godwin, describes a simulated football board game having playing cards and dice. There is little room in this game for offensive strategies and defensive guessing. Dice are used in unique ways to announce plays and results.

It is well known in the prior art to have a game board that includes a simulated football board field having player pieces and a line to gain marker which are moved along a simulated field on the playing board. The movement of the playing pieces is determined by decks of cards that designates the type of offensive plays, such as run, pass, punt, field goal and extra point. Also, the cards contain wording indicating the result of a selected football play, and the playing pieces move in accordance with the instructions on the cards. Note that betting areas are available on the board for placing bets on the outcome of a football play or a series of football plays as the proceeds. The prior art teaches the concept of having a game board divided into quadrants for the players. Each quadrant representing a betting area on which bets may be placed for indicating different possible outcomes of a football play or a series of football plays. This simulated game is described in U.S. Pat. No. 4,706,959, issued Nov. 17, 1987 to Frank O. Price.

Also, there are card-based simulated football games that allow players to utilize their mental skills in planning and executing various offensive and defensive plays in an environment that closely simulates the actual game itself. See U.S. Pat. No. 5,040,796 issued Aug. 20, 1991 to John T. Schall that describes such card-based simulated football game.

The prior art also teaches a simulated football game having a board with a grid pattern dividing the surface into individual player piece location segments. This apparatus further includes a plurality of player pieces movable on the board surface, setup cards having at least a portion of the board surface including the grid pattern reproduced in reduced scale on the cards for accurate initial setup of the player pieces in the segments according to the cards and a movement indicator for determining player piece movement along the board. See U.S. Pat. No.5,221,084 issued Jun. 22, 1993 to Tom Stelmach.

### SUMMARY OF THE INVENTION

The present invention comprises a computerized game that includes a monitor with a simulated football field. The monitor includes a plurality of game select buttons thereon that are used as selective controls to select specific plays. The specific plays are RUN, FIELD GOAL (F/G), EXTRA POINT (E/P) and PASS. Computerized yard line-to-gain indicators or markers are positioned on the simulated football field and the monitor to show the progress of the game to the players.

There are three decks of cards that relate to randomly select plays that are controlled by a master program, which determines the movement of a football image. Note that the different designations of the aforementioned specific plays RUN, F/G and E/P are the heart and soul of the game. Each of the cards contain text or wording that indicates the result of a selected football play that causes the football image to move due to the master program. The cards are automatically shuffled as a function of the master program before and after a player plays.

In addition to the plurality of game select buttons, the computerized yard line-to-gain indicators or markers and the three decks of programmed cards, the monitor further includes an animated video and graphic screen, a master display scoreboard, a coin slot and a start (on/off) button. The scoreboard includes a 4-down indicator section labeled “ATTEMPTS” for keeping track of the number of times the yard line-to-gain is reset after a first down or 10 yards has been gained. Secondly, the master scoreboard includes a play number section labeled “DOWN” for tracking the play number after each player's play. Also, the master scoreboard has a yard-to-go indicator section labeled “YDS TO GO” that tells how many yards the player needs for a first down. Finally, the scoreboard has a section labeled “SCORE” for displaying and accumulating the score of a player each time the player scores.

The monitor of the instant invention further includes a simulated football field with hash yard lines and markers, a goal line and an end zone. The preferred invention shows the START, RUN, F/G, E/P, PASS buttons, and the coin slot are positioned at a lower portion of the monitor. The yard markers are positioned on both sides of the graphic and video screen and aligned with the hash lines on the simulated football field on the screen. The yard markers are labeled G (goal line) to 50 in increments of 5's starting from the goal line. Below the goal line on the screen is a section that is labeled END ZONE. This END ZONE is located just above the aforementioned game select buttons. Above the 50 yard line marker on the simulated football field, the scoreboard is positioned in an upper left hand corner and the card display is positioned in the upper right hand corner.

To one of ordinary skill in the art at the time the invention was made, it would be obvious to position the above elements, the game select buttons, hash lines and markers, card display and the labeled END ZONE in different locations or arrangements on the monitor and the screen versus what is described above, if desired.

This simulated football game can be utilized as an electronic game for an adult in a casino environment. This electronic game can be of various sizes, if desired. It can be of a portable or hand carrying size, as well as a large unit.

### BRIEF DESCRIPTION OF THE DRAWINGS

FIG. 1 illustrates an isometric view of the RAID-ZONE football game according to the present invention.

FIG. 2 illustrates a front plan view of the monitor and screen components according to the present invention.

### DETAILED DESCRIPTION

Reference will now be made in detail to the preferred embodiments of the invention, examples of which are illustrated in the accompanying drawings. While the invention will be described in conjunction with the accompanying drawings, it will be understood that they are not intended to limit the invention to drawings. On the contrary, the present invention is intended to cover alternatives, modifications and equivalents, which may be included within the spirit and scope of the invention as defined by the appended claims.

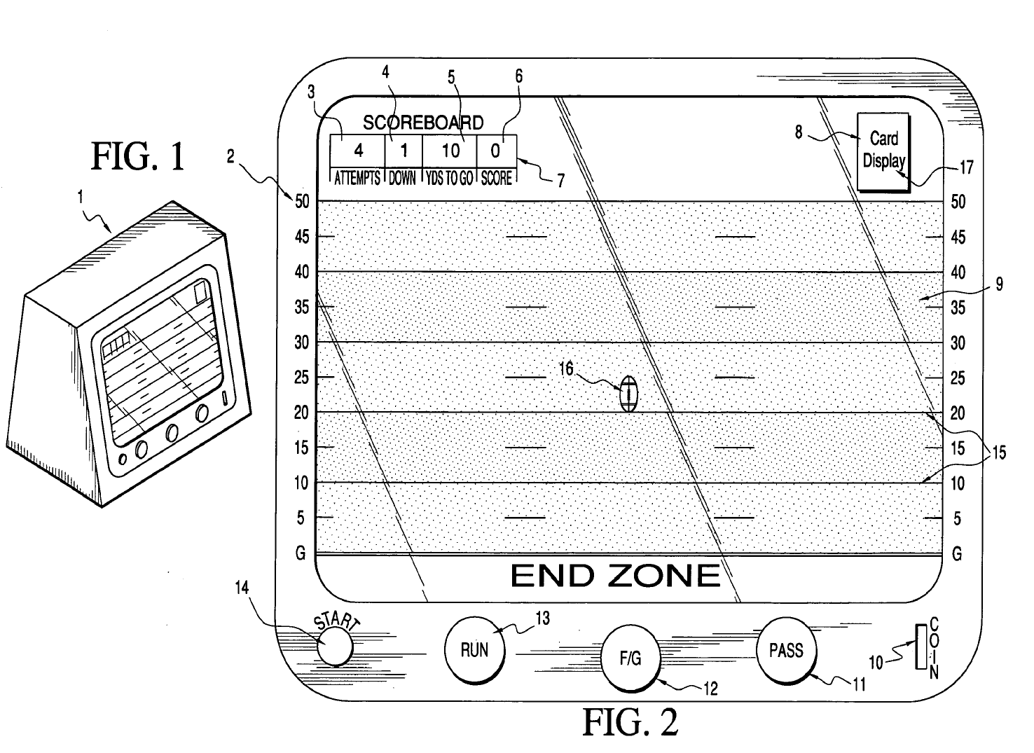

FIG. 1 shows the isometric view of the simulated RAID-ZONE football game 1.

In FIG. 2, the RAID-ZONE simulated football game device 1 includes a monitor 2, with a screened simulated football field 9. The monitor defines a housing structure or enclosure with a front portion, a pair of side wall portions and a rear wall portion. Even though it is not shown, the rear wall portion has at least an electrical connector for receiving an electrical power cord and USB connector ports for receiving other computer related accessories. The screened simulated football field 9 has a display scoreboard 7 that is connected to a main game database that is controlled by football game software. This scoreboard 7 includes a 4-down indicator section 3 labeled “ATTEMPTS” for keeping track of the number of times the yard line-to-gain is reset after a first down or 10 yards has been gained. Secondly, the scoreboard includes a play number section 4 labeled “DOWN” for tracking the play number after each player's play. The scoreboard has a yard-to-go indicator section labeled 5 “YDS TO GO” that tells how many yards the player needs for a first down. Also, the scoreboard has a section labeled 6 “SCORE” for displaying and accumulating the score of a player each time the player scores. The scoreboard is connected to and controlled by the database software. The monitor further includes a card display 8 displaying the 3 decks of programmed cards. The above described elements 3-8 are positioned on the screened simulated football field 9. As shown, the scoreboard 7 is positioned in an upper left hand corner and the card display 8 is positioned in the upper right hand corner of the screened simulated football field 9. Note that the scoreboard elements 3-7 and the card display 8 can be oriented on the monitor 2 or the screened simulated football field 9 at any location desired, by one of ordinary skill in the art the time the invention was made.

At a lower portion of the monitor 2, a plurality of game select control buttons 11-13 is positioned thereon. These select control buttons define the select plays PASS 11, F/G 12, RUN 13 and START 14. Note that a player can also use the F/G 12 select control button to perform an E/P. Also, the coin slot 10 is positioned on the lower portion of the monitor in alignment with the select control buttons 11-13. Note that coins or tokens can be utilized, if desired.

On the outer periphery edges of the monitor 2, the yard markers are positioned on both sides thereon and in alignment with hash and yard lines 15 on the screened simulated football field 9. The yard markers are labeled G (goal line) to 50 in increments of 5's starting from the goal line. Below the goal line on the screen is a section that is labeled END ZONE. This END ZONE is located just above the aforementioned game select buttons 11-13 and the coin slot 10. It is obvious to one of ordinary skill in the art, at the time the invention was made, to orient or position elements 10-14 on the monitor 2 at different locations other than the locations shown in FIG. 2, if desired.

The card display 8 is representative of the specific plays controlled by the game select control buttons 11-13. The game select buttons 11-13 select a specific card from the 3 decks of computerized shuffled cards to be selectively displayed on the card display 8. This determines how far the football image 16 moves from one hash line 15 to the other hash line 15. Each of the computerized cards contain text or wording that indicates the result of a selected football play that controls the football image by a computer software (not shown) and will not be described as part of the claimed invention.

The 3 decks of computerized cards actually represent 3 distinct internal arrays to the master program. The program displays the deck of cards graphically on the card display 8 for users or players and also goes into a continuous loop for reshuffling the computerized cards. The computer software controls reshuffling of each deck of cards. An internal button or icon (not shown) can interface directly with the 3 deck of cards, whereby players are informed that the computer software reshuffles the 3 decks of computerized cards

It is to be noted that a variety of results of plays can be included in each of the 3 decks of cards as shown on card display 8. The 3 decks of cards of the instant invention have 51 Pass cards controlled by game select button 11, 23 Field Goal/Extra Point controlled by select button 12 and 52 Run cards controlled by select button 13. Randomly cards are selected representing different types of offensive plays relating to pass plays, run plays and field goal/extra point plays. Each deck is preferably comprised of wording/text, on which are written the results of the selected football play. These cards control the movement of player image 16 on the screened simulated football field 9. This is illustrated in the following charts.

| Number of Cards | Wording/Text on Each Card |
|---|---|
| 7 | Complete for 3 yards (FB) |
| 5 | Complete for 5 yards (RB) |
| 4 | Complete for 7 yards (TE) |
| 1 | Complete for 10 yards (FB) |
| 1 | Complete for 12 yards (TE) |
| 1 | Complete for 15 yards (WR) |
| 2 | Complete for 20 yards (WR) |
| 1 | Complete for 35 yards (RB) |
| 1 | Complete for 40 yards (WR) |
| 1 | Complete for 50 yards (WR) |
| 1 | Complete for 5 yards. Right |
| 1 | Offensive Guard was holding. Ten yard |
| | penalty from the spot of the snap. Repeat |
| | the down. (WR) |
| 1 | Complete for 5 yards. Offensive End |
| | was holding. Ten yard penalty from the |
| | spot of the snap. Repeat the down. (RB) |
| 2 | Complete for 7 yards. The Center was |
| | holding. Ten yard penalty from the spot |
| | of the snap. |
| 1 | Incomplete, defensive pass interference. |
| | Penalty, first down and 15 yards beyond |
| | the spot of the snap. |
| 14 | Incomplete. |
| 4 | Try resulted in a sack for a five yard lost. |
| 1 | Illegal forward pass 1 yard beyond the |
| | spot of the snap. Five yard penalty from |
| | that spot and a lost of down. |
| 1 | Offensive pass interference. Five yard |
| | penalty and a loss of down. |
| 1 | Intercepted 15 yards down field. |
| 1 | Intercepted 11 yards down field. |
| 1 | Intercepted 5 yards down field. |

### The Running Deck (51 Cards) (Select Button 13)

| Number of Cards | Wording/Text on Each Card |
|---|---|
| 3 | Gained 3 yards on this run. (RB) |
| 4 | Gained 2 yards on this run. (QB) |
| 16 | Stopped for no gain. |
| 4 | Gained 5 yards on this run. (WR) |
| 3 | Gained 4 yards on this run. |
| 1 | Gained 4 yards on this run. Fumbled |
| | and lost possession of the ball. (FB) |
| 3 | Gained 6 yards on this run. (WR) |
| 3 | Gained 7 yards on this run. (RB) |
| 2 | Gained 8 yards on this run. (QB) |
| 2 | Gained 10 yards on this run. (RB) |
| 2 | Gained 15 yards on this run. (FB) |
| 1 | Gained 20 yards on this run. (QB) |
| 1 | Gained 40 yards on this run. (WR) |
| 2 | Gained 4 yards on this run. The |
| | Offense was off side. Penalty, 5 yards |
| | from the spot of the snap. Repeat the |
| | down. |
| 3 | Gained 6 yards on this run. The |
| | offensive guard was holding 2 yards |
| | behind the spot of the snap. Penalty, 10 |
| | from the spot of the snap. Repeat the |
| | down. |
| 1 | Gained 17 yards on this run. Fumbled |
| | and lost possession of the ball. (FB) |
| 1 | Gained 13 yards on this run. Fumbled |
| | and lost possession of the ball. (RB) |

### The Field Goal/Extra Point Deck (23 Cards) (Select Button 12)

| Number of Cards | Wording/Text on Each Card |
|---|---|
| 3 | Attempted field goal missed. |
| 1 | Fake attempt ran for 2 yards. (QB) |
| 1 | Fake attempt ran for 5 yards. (QB) |
| 1 | Attempt travels 50 yards. The right |
| | offensive guard was off side. 5 yard |
| | penalty, 5 yards and re-kick. |
| 2 | Fake kick and pass incomplete. |
| 7 | Attempt traveled 30 yards. |
| 2 | Attempt traveled 50 yards. |
| 3 | Attempt traveled 40 yards. |
| 2 | Attempt traveled 25 yards. |
| 1 | Attempt blocked-5 yard lost. |

Now the computer video graphic/animation, software design/coding, memory design, and individual components/programming design will now be discussed.

The computerized version of Raid-Zone Football dictates a video graphic design and animation scheme, which is necessary in order to effectively communicate with the players of the game. The actual game area is projected with a built-in video counter or clock for score keeping. Animation is required in order to inform the user as to what activity the computer is presently pursing. Such animation brings the game to life and causes excitement with each player, as each player watches the computer execute activities such as runs, passes, touchdowns, field goals and extra points. Note that the different officials that include the umpire, head linesman, field judge and referee are built into the graphics scheme and animation of the computerized version.

The software design emulates the actual rules and parameters of the game and is automatically adhered to by the system. The software is designed in a high-level language in order to allow anyone with reasonable skill in the field to build and test the instant invention. This software addresses the actual control of the game score keeping and all other interfaces of the game. Every aspect of the control of the control system as well as the application programming of the game's internal logic establishes as to how the simulated football game operates. The software is designed to be implemented on a personal computer as a means of simulation. This software is designed to operate on a particular class of hardware that is specifically selected for the purpose and design of this football game.

Mass memory within the computer system tracks multiple games in progress at one time. Special memories was employed to store clock information, points and scores, player names and other functions required by the simulated football game. At least 40 Mega-Bytes of memory is sufficient to support one player at a time.

Some of the individual components of the football game, such as, the monitor 2, the coin slot 10 provisions, the components of scoreboard 7, and the field simulation computerized officials, which are represented as sub-routines HL (head linesman), U (umpire), R (referee) and FJ (field judge) are controlled by the software program with some of the results from these components being displayed on the monitor 2.

The object of the game is to score as many points as one can in order to receive any return from the simulated football game as programmed by the software program. The main challenge is to hit the Jack Pot. This is achieved when a player scores a maximum of 32 points from any combination of touchdowns, extra points and/or field goals (which is harder to get). Note that other scores less than 32 points are possible, which might be easier to get in order to receive a pay out.

The computerized simulated football game will now be described. FIG. 2 displays the computerized simulated football game as illustrated on the monitor 2. In playing the game, a player will first insert coin(s) or token(s) as determined by the software program into the coin slot 10 and then press the start button 14 which will begin the game. Once the start button 10 has been pushed the 3 decks of cards (which represents the selected game play) will automatically be reshuffled before the player begins. The computer software program will automatically officiate the game, plus manage the first down markers and indicate the position of the ball on the scoreboard 7 and the simulated. Also, the computer software program will automatically set up the player image 16 to begin from the 20 yard line. Once the player image 16 is set, the player will push one of the games select control buttons 11-13 and a random select card will be automatically displayed on the card display 8 as a result of the software program. This random select card will determine where the player image 16 will be moved to on the screened simulated football field 9 in order to score either a touchdown and extra point or a field goal. Note that in order to score, the player image 16 must gain 10 yards or a first down to continue with 4 new series of downs or the player only has 4 downs to get a first down or gain 10 yards. After the player gets a first down or gain 10 yards he will continue to select a random select card selected by one of the games select control buttons 11-13, which dictates whether the player image 16 will have a gain, no gain, interception and loss of yards (this can happen many ways as depicted on the random select cards). Also, this determines which direction the player image 16 will move from the 20 yard line (that is backward or forward).

After 4 series of downs the game terminates and the indicator on the scoreboard will say that the “Game is Over”. The ball is reset at the 20 yard line for each new series or downs or attempts. The player will have to start over by placing the required amount of coins in the slot 10 and repeat the above steps in order to continue trying to win a pay out.

In conclusion, the basic concept of the game was structured to hold everyone's attention by having players in a position to win on each draw of a card. This feature will enhance the enjoyment of the game.

The foregoing descriptions of the specific embodiments of FIGS. 1 and 2 have been presented for purposes of illustration and description. They are not intended to be exhaustive or to limit the present invention to the precise forms disclosed, and obviously many modifications and variations are possible in the light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined as set forth in the following claim(s).

What is claimed is:

1. (canceled)

2. (canceled)

3. (canceled)

4. (canceled)

5. A computerized simulated football game device adapted for use by players to play a simulated football game to win a pay out, the computerized football game device comprising:
a monitor having a pair of yard down markers disposed exteriorly of the monitor along opposite peripheral edges, the yard markers begin with a goal line marker G to a 50 yard line marker in increments of 5 yards there between;
a plurality of game select play buttons, a coin slot and a start button disposed on an outer surface thereon, the plurality of game select play buttons are designated RUN, FG/EP and PASS;
at least 3 separate decks of play select cards disposed internally of the monitor that are controlled selectively and randomly by the designated RUN, FG/EP and PASS select play buttons;
a screened simulated football field disposed within the monitor and is viewed on a front side thereof;
a scoreboard indicator and a card display indicator are cooperatively associated with the screened simulated football field; and
a player image that is automatically positioned at the 20 yard line at the start of a game;
wherein the player image can only be moved in opposite directions on the screened simulated football field after a player inserts the required amount of coins into the coin slot and then press the start button to enable the player to select a play by pushing one of the designated RUN, FG/EP and PASS select play buttons which will randomly select a play from one of the 3 separate decks of play select cards to move the player image forward or backwards or not move the player image when there is no gain as displayed on the random select cards, as the player attempts to score by trying to get a first down or 10 yards in four series of down attempts to continue the game in order to cross the goal line G to score a maximum of 32 points to hit the jack pot.

6. The computerized simulated football game device according to claim 1, wherein the scoreboard and the card display indicators are positioned and spaced from each other at an upper surface portion of the screened simulated football field and positioned above the 50 yard line marker.

7. The computerized simulated football game device according to claim 1, wherein the scoreboard further comprising four display indicators designating a number of play attempts that a player used to try to score, a number of play downs up to a maximum of four downs to get a first down or 10 yards or to score a touchdown, field goal or extra point and a score accumulator for compiling a player's score.

8. The computerized simulated football game device according to claim 1, wherein the screened simulated football field includes a plurality of yard and hash lines that are in direct alignment with the yard line markers, whereby the plurality of yard and hash lines indicates where the player image is positioned on the screened simulated football field after each play relative to the yard markers.

9. The computerized simulated football game device according to claim 1, wherein the plurality of game select play buttons, the coin slot and the start button are located on a lower outer peripheral surface of the monitor.

10. The computerized simulated football game device according to claim 1, wherein an end zone area is located at a lower end of the simulated football field below the goal line G and extend substantially the entire length of the goal line that extends between the yard markers disposed on the monitor and positioned above the plurality of game select play buttons, the coin slot and the start button.
